(19) United States
(12) Patent Application Publication
(10) Pub. No.: US 2026/0194148 A1
(43) Pub. Date: Jul. 9, 2026

(54) CHARACTERIZED DISC RETENTION

(71) Applicant: Bray International, Inc., Houston, TX (US)

(72) Inventors: Ananda PRASATH, Chennai (IN); Vinod Gopalakrishnan, Chennai (IN); Shanmugam Sukumar, Chennai (IN); Satish Srinivas, Bengaluru (IN); Kishorekumar Vijayaram, Cypress, TX (US); Justin Bernard, Houston, TX (US)

(21) Appl. No.: 19/441,390

(22) Filed: Jan. 6, 2026

Related U.S. Application Data
(60) Provisional application No. 63/742,524, filed on Jan. 7, 2025.

(51) Int. Cl. F16K 5/08; F16K 5/06

(52) U.S. Cl. CPC F16K 5/08; F16K 5/06

(57) ABSTRACT

The disclosure relates to a retention arrangement for a characterized disc for a diverter port in a valve body, wherein the characterized disc for the diverter port has a first surface and a second surface, and includes a retainer ring wherein the retainer ring has a first retainer ring side and a second retainer ring side, wherein the retainer ring is adjacent to the characterized disc for the diverter port.

### BACKGROUND

Technical Field: The disclosure relates to characterized disc assembly arrangements for characterized ball valves. Characterized Ball valves are extensively used in HVAC applications. Ball valves fall under a family of valves called quarter-turn valves. These valves are used to stop, regulate, or start the flow of medium or fluid in the pipeline. There are several types of ball valves, one among which is a characterized ball valve.

Most conventional characterized ball valves are manufactured with an inbuild characterized disc in diverter seat, thus each valve needs to assembled with the inbuild characterized disc in diverter seat based on customer requirements and needs to undergo production test only after the receipt of customer order. This results in significant delays and costs, even lost production. Further, conventional characterized ball valves need proper identification of characterized disc in the inventory which may often get misassembled during a busy operation, and lead to incorrect assembly of inbuild characterized disc in diverter seat. In conventional characterized ball valves, the inbuild characterized disc in diverter seat may tend to wear during the service and affect the valve flow coefficient value (hereinafter, also referred to as the “Cv” or “Cv value”).

Therefore a need exists for an improved diverter characterized disc retention arrangement in characterized ball valves capable of independent replacement of the diverter characterized disc, which allows the valve to be assembled without the characterized disc in the diverter port and undergo production test without the characterized disc in the diverter port. Moreover, a need exists for the replaceability of the characterized disc in the diverter port without dismantling the valve, without requiring the valve to undergo a production test, and for improved leakage prevention and control in the diverter port. These improved valves can be kept in inventory and may be assembled with a specific characterized disc as per the customer requirements for valve flow coefficient or Cv value, thus resulting in time and cost saving.

### SUMMARY

The disclosure relates to a retention arrangement for a characterized disc for a diverter port in a valve body, wherein the characterized disc for the diverter port has a first surface and a second surface, and includes a retainer ring wherein the retainer ring has a first retainer ring side and a second retainer ring side, wherein the retainer ring is adjacent to the characterized disc for the diverter port.

The disclosure further relates to retention arrangement for a characterized disc for a diverter port in a valve body, wherein the characterized disc for the diverter port has a first surface and/or a second surface, having a retainer ring wherein the retainer ring has a first retainer ring side and/or a second retainer ring side, wherein the retainer ring is adjacent to the characterized disc for the diverter port; and/or wherein the first surface of the characterized disc for the diverter port is positioned against a shoulder defined in the diverter port of the valve body and/or the second surface of the characterized disc for the diverter port is positioned facing a valve opening; and/or wherein the retainer ring is inserted into a groove defined in the diverter port of the valve body, and/or wherein the retainer ring is adjacent to the second surface of the characterized disc for the diverter port; and/or a diverter seat having a first end, an exterior surface and/or an interior surface, and/or wherein the characterized disc for the diverter port is inserted into the diverter seat and/or in contact with the interior surface, and/or wherein the first end of the diverter seat is in sealable contact with a ball of the valve; and/or wherein the characterized disc for the diverter port is configured to be removable and/or replaceable from the diverter seat without affecting a seating integrity of the diverter seat; and/or a second end of the diverter seat, wherein the second end of the diverter seat is opposite the first end of the diverter seat, and/or where in the second end of the diverter seat is adjacent to the shoulder; and/or wherein the valve body further comprises a straight port and/or a straight port seat inserted into the straight port, and/or wherein the diverter seat does not contact the straight port seat when installed in valve body.

The disclosure also relates to a valve having a straight port and a diverter port defined in a valve body, and a ball rotatable within the valve body between an open position and a closed position of the diverter port having a characterized disc in the diverter port, wherein the characterized disc has a first end and a second end; and/or a retaining ring installed into a groove defined in the valve body and/or wherein the retaining ring is adjacent to the first end of the characterized disc in the diverter port; and/or a diverter seat installed into the valve body and in the diverter port, and/or wherein the diverter seat is located towards the second end of the characterized disc and/or the diverter seat is configured to seal against the ball; and/or wherein the characterized disc in the diverter port is removable and/or replaceable from the diverter seat; and/or a shoulder defined in the diverter port of the valve body, wherein the shoulder comprises a first side surface, a second side surface, and/or a raised top surface connecting the first side surface and/or the second side surface; and/or a flange of the characterized disc in the diverter port, wherein the flange is located at the first end of the characterized disc, and/or wherein an underside of the flange is adjacent the first side surface of the shoulder; and/or wherein a first end of the diverter seat is adjacent to the second side surface of the shoulder; and/or a seat in the straight port and/or wherein the diverter seat does not contact the seat in the straight port when the valve is assembled; and/or wherein the diverter seat defines a first area configured to seal against the ball, and/or the seat in the straight port comprises a second area configured to seal against the ball, and/or wherein the first area is less than the second area.

The disclosure further relates to a method of assembling a valve having a valve body with a straight port and a diverter port, having the steps of: inserting a ball into the valve body, and a stem into the ball; and/or inserting a first seat with an O-ring into the straight port, wherein the first seat is adjacent to and sealable against the ball; and/or inserting a second seat into the diverter port, wherein the second seat is adjacent to and/or sealable against the ball and/or is further noncontiguous with the first seat; and/or inserting a characterized disc into the diverter port and/or the second seat, wherein an exterior surface of the characterized disc is adjacent an interior surface of the second seat; and/or inserting a retaining ring into the diverter port, and/or adjacent to the characterized disc; and/or removing the retaining ring from the diverter port and/or removing the characterized disc from the diverter port without affecting a seating integrity of the second seat; and/or inserting a second characterized disc into the diverter port and/or into the second seat, without affecting the seating integrity of the second seat; and/or wherein the interior surface of the diverter port defines a shoulder having a first side surface and/or a second side surface and/or a top surface connecting the first side surface and/or the second side surface, and/or wherein a first end of the second seat abuts the first side surface of the shoulder, and/or the characterized disc abuts the second side surface of the shoulder.

### BRIEF DESCRIPTION OF THE DRAWINGS

The exemplary embodiments may be better understood, and numerous objects, features, and advantages made apparent to those skilled in the art by referencing the accompanying drawings. These drawings are used to illustrate only exemplary embodiments, and are not to be considered limiting of its scope, for the disclosure may admit to other equally effective exemplary embodiments. The figures are not necessarily to scale and certain features and certain views of the figures may be shown exaggerated in scale or in schematic in the interest of clarity and conciseness.

FIG. 1 depicts an exploded view of an exemplary embodiment of a characterized ball valve with an assembled improved retention arrangement for a characterized disc in the diverter port.

FIG. 2 depicts a partial, horizontal midplane cross sectional view of an exemplary embodiment of a characterized ball valve with an assembled improved retention arrangement for a characterized disc in the diverter port.

FIG. 3 depicts a perspective view of an exemplary embodiment of an assembled characterized ball valve with an exploded perspective view of an exemplary embodiment of the retaining ring and characterized disc of the assembled improved characterized disc retention arrangement.

FIG. 4 depicts a perspective view of an exemplary embodiment of a fully assembled improved characterized disc retention arrangement for the characterized disc, diverter in a valve.

FIG. 5 depicts a perspective view of an exemplary embodiment of a retainer ring of an exemplary embodiment of a characterized ball valve with an assembled improved retention arrangement for a characterized disc in the diverter port.

FIG. 6 depicts a front, perspective view of an exemplary embodiment of a characterized disc for a diverter port of a characterized ball valve.

FIG. 7 depicts a rear perspective view of the exemplary embodiment of the characterized disc for a diverter port of FIG. 6.

FIG. 8 depicts a partial top cross sectional view of a fully assembled improved characterized disc retention arrangement in a characterized ball valve.

FIG. 9 depicts a front isometric view of an exemplary embodiment of a diverter seat in a valve body.

FIG. 10A depicts a top cross section view of an exemplary embodiment of the diverter seat in the valve body of FIG. 9.

FIG. 10B depicts an enlarged top cross section view of the diverter seat in the valve body of FIGS. 9 and 10A.

### DESCRIPTION OF EMBODIMENT(S)

The description that follows includes exemplary apparatus, methods, techniques, and instruction sequences that embody techniques of the inventive subject matter. However, it is understood that the described embodiments may be practiced without these specific details.

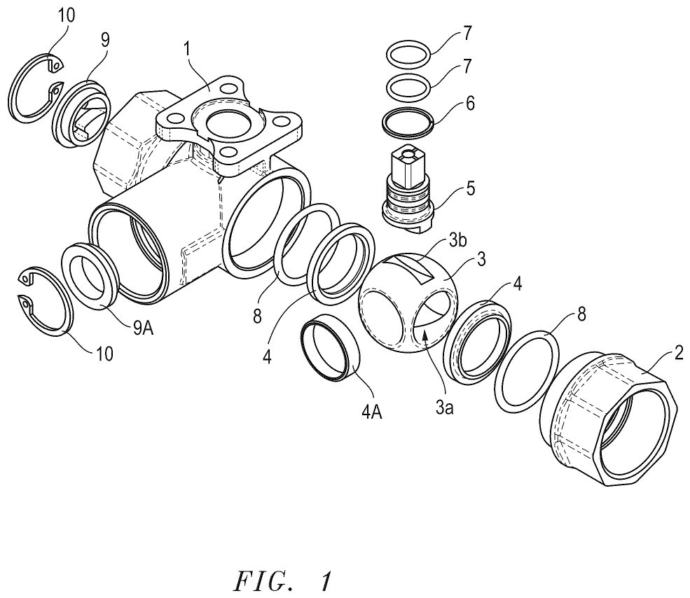

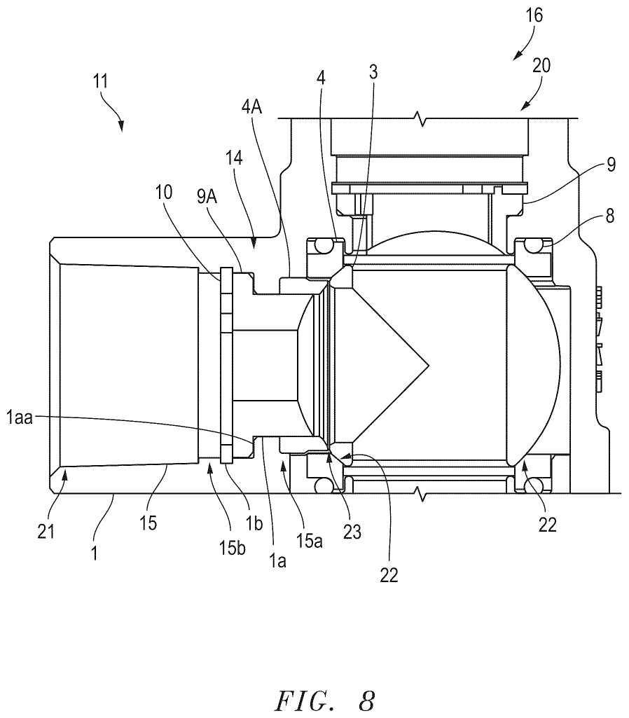

FIG. 1 depicts an exploded view of an exemplary embodiment of a characterized ball valve 11, valve body 1, endcap 2, control element or ball 3, seat 4, diverter seat 4A, stem 5, thrust washer 6, O-ring for the stem 7, O-ring for the seat 8, characterized disc 9 for the straight port 20, characterized disc 9A for diverter port 21, and retainer rings 10. The valve body 1 may have straight ports 20 at either end of the valve 11, and an angle or diverter port 21 at an angled or perpendicular position to said straight ports 20 (see, e.g. FIG. 4 having two straight ports 20 at ends opposite of the body 1, and diverter port 21). The control element or ball 3 is situated within the valve body 1, and has an opening or bore 3a which may allow one or both straight ports 20 to connect with or flow into or flow from diverter port 21, as dependent on the open position of the opening 3a; further, the opening 3a may also have closed position(s) which prevent any flow into or out of the diverter port 21, as in relation to the straight port(s) 21. As can be seen in FIG. 8, one such open position of the valve 1 allows fluid connectivity between both straight ports 20 and the diverter port 21. One or both of the straight ports 21 may have an annular or ring shaped seat 4 within the port 21 and adjacent to the ball 3, wherein the seat 4 may seal against an outer surface of the ball 3 to prevent leaking through the straight port 21; an O-ring 8 positioned around the seat 4; a characterized disc 9 for the straight port 21 configured to adjust the Cv of a flow through the straight port 21; a retainer ring 10 for retaining or holding the characterized disc 9 into position within the straight port 21; and an endcap 2 set onto the ends of the straight ports 21 for securing the aforementioned ball 3, seats 4, O-rings 8, characterized disc 9, and retaining ring 10 for characterized disc 9 in the straight port 21 openings.

The top of the ball 3 may have a slot or keyway 3b for use with the stem 5. The stem 5 is inserted into the body 1 and keyed to the slot or keyway 3b so that actuation or rotation of the stem 3 transfers the same rotational motion to the ball 3 for positioning the ball opening 3a and to control the flow of fluid through the valve 1. A thrust washer 6 and one or more O-rings 7 may be placed on top of the stem 5 and within the body 1.

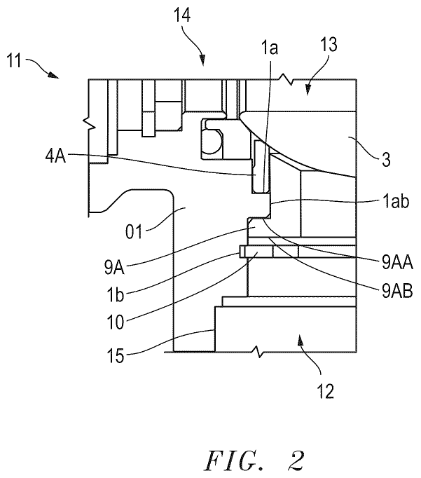

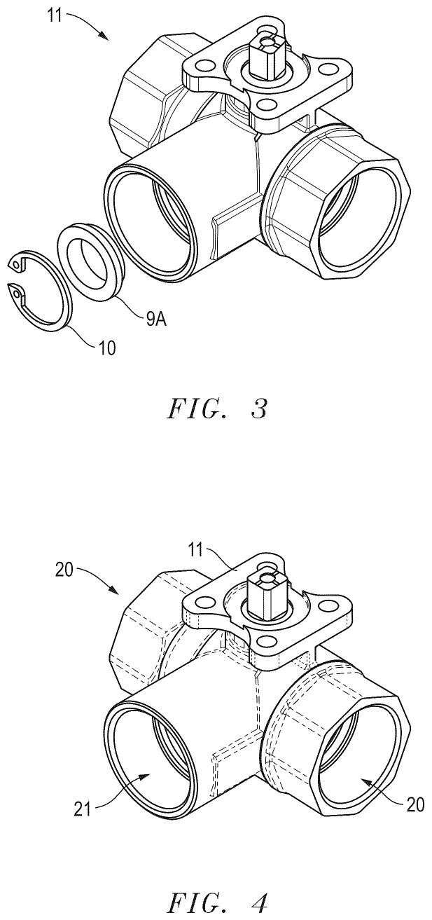

FIGS. 2-3 depict an enlarged cross-sectional view and an assembly view of the exemplary embodiment of the characterized ball valve 11 having the assembled improved characterized disc retaining arrangement system, or apparatus 14 for a characterized disc 9A for the diverter or diverter port 21, wherein the characterized disc 9A for the diverter 21 and retainer ring 10 may be assembled or inserted after assembly of all other components (such as, the components for the straight port 20, the stem 5 and stem 5 components, and the diverter port seat 4A) in characterized ball valve 11, and wherein the characterized disc 9A for the diverter 21 and retainer ring 10 may also be removed without disturbing or perturbing the other assembled components of the ball valve 11. The characterized ball valve 11 includes at least: a valve body 1 defining a valve opening, throughbore, or hatch 12 through which a fluid may flow through the diverter port 21; a control element or ball 3 which is configured to restrict Cv through the valve opening 12 between a fully closed position 13, which blocks or prevents fluid flow through the valve opening 12, and various open, including partially open, positions which allow fluid through the valve opening 12; and an improved characterized disc diverter port retention arrangement 14 configured to engage the retainer ring 10 and characterized disc 9A for the diverter port 21, and prevent disassembly of same from the characterized ball valve 11. The removable characterized disc, diverter 9A along with retainer ring 10 can be assembled into the ball valve 11 regardless of whether the ball 3 is in an open or closed position.

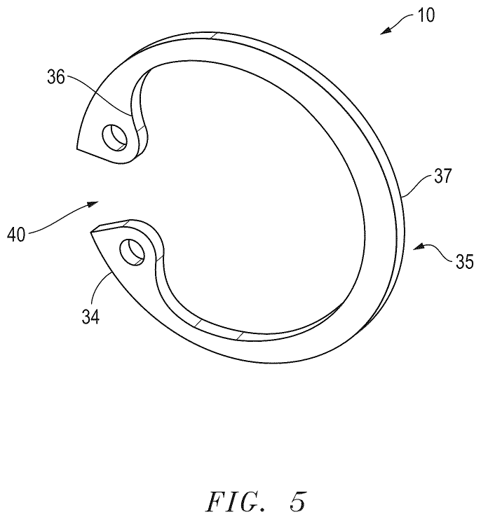

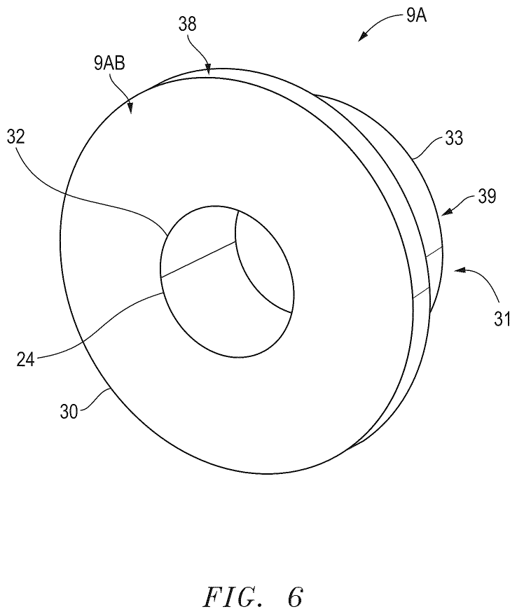

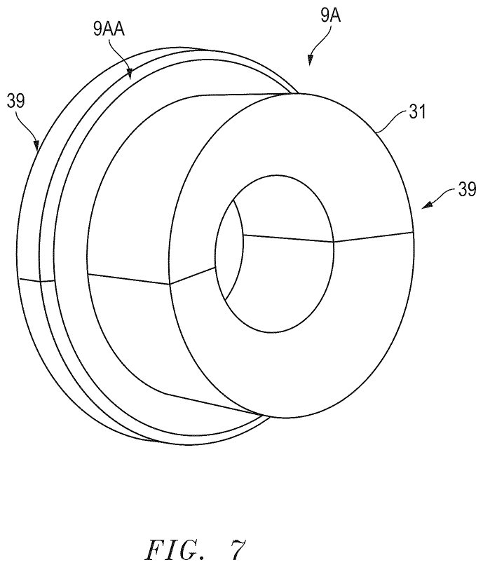

The improved characterized disc retention arrangement 14 includes at least the characterized disc 9A for the diverter 21 and the retainer ring 10. The valve opening or throughbore 12 of the diverter port 21 may have a substantially circular circumference defined on the interior surface 15 of the valve body 1 (see e.g., at least FIGS. 2-4 and 8). The components of the characterized disc retention arrangement 14 for retaining or holding the characterized disc 9A for the diverter 21, including the retaining ring 10, are inserted within the valve opening 12, adjacent to and along the circular circumference of the valve opening 12; accordingly, each of the characterized disc 9A and the retaining ring 10 may have a substantially annular, ringed, or ring-like shape with each having a first surface and a second surface connected by an interior surface and an exterior surface, wherein the interior surface of each is facing, nearer or adjacent to the throughbore 12, and wherein the exterior surface of each is facing, nearer or adjacent to the valve body 1. By way of example, referring to at least FIGS. 5-7, characterized disc 9A may have a first or top surface 30 and a second or bottom surface 31 connected by an interior surface 32 and an exterior surface 33, and retaining ring 10 may have a first or top surface 34 and a second or bottom surface 35 connected by an interior surface 36 and an exterior surface 37.

In addition the characterized disc 9A may have a flange 38 at one end of the characterized disc 9A, towards the opening 12, and a cylindrical body or tube 39 at the opposite end of the characterized disc 9A, as facing towards the ball 3, with an opening defined through the flange 38 and the body 39. The flange 38 may have first surface 9AA and a second surface 9AB, wherein the second surface 9AB is opposite the first surface 9AA (the latter surface 9AB may be coterminous to or the same as the surface 30). The surface 9AA may face the shoulder 1a and the surface 9AB may face the retaining ring 10 when installed in the valve 11. The characterized disc 9A may be, in certain exemplary embodiments, and not to be limited to, made of polyphthalamide or other polyamide material. The retainer ring 10 may optionally define a gap 40 along the retainer ring 10 annular shape.

One aspect of the sealing in the diverter port 21 of the characterized ball valve 11 happens between the diverter seat 4A and the ball 3, for example when the characterized ball valve 11 is in closed position 13 (by way of example, the valve 11 is in a closed position 13 in FIG. 2). The characterized disc 9A of the diverter 21 is a crucial component of a characterized ball valve 11, allowing custom Cv for the valve 11. Improper retention of the characterized disc 9A in the diverter port 21 will affect the Cv of valve 11. In the improved characterized disc retention arrangement 14 as shown, the characterized disc 9A of the diverter port 21 is retained in valve body 1 via the retaining ring 10.

Referring at least to FIGS. 2 and 8, the valve body 1 has a cylindrical interior surface 15 at the opening 12 of the diverter port 21. The interior surface 15 at the opening 12 of the diverter port 21 defines at least a first recessed surface 15a at an end closest to the ball 3; a shoulder or extension 1a adjacent to and raised from the recessed surface 15a at one end or side of the shoulder 1a, wherein the shoulder 1a has a raised top surface 1ab connecting two side surfaces 1aa; a second recessed surface 15b at the opposite side of and adjacent to the shoulder 1a, wherein the first recessed surface 15a and second recessed surface 15b are connected to the shoulder 1a each via a shoulder side surface 1aa; and a groove or slot 1b defined within the second recessed surface 15b for receiving the retaining ring 10.

Referring further to the FIGS. 2 and 8, the first surface, side, or underside 9AA of the flange 38 of the annular or ring-shaped characterized disc 9A may be installed within the valve body opening 12 in the diverter port 21, against an interior surface 15 of the valve body 1. In certain exemplary embodiments, as depicted, the flange 38 of the characterized disc, diverter 9A may be installed against or adjacent to the shoulder, raised surface, or extension 1a of the interior surface 15 of the valve body opening 12 in the diverter port 21, or specifically, the surface 9AA of the flange 38 of the characterized disc 9A may abut a side surface 1aa of the shoulder 1a. As installed, the exterior surface 33 of the body or tube portion 39 of the characterized disc 9A may abut or engage a second or top surface 1ab of the shoulder 1a, and also abut or engage the interior of the diverter port seat 4A. The characterized disc 9A is located or rests on the valve body 1 and the shoulder or raised surface 1a in the assembled improved characterized disc, diverter retention arrangement 14. The second surface or side 9AB of the characterized disc 9A is located across from the first side 9AA of the characterized disc, diverter 9A. The retainer ring 10 (having an annular or ring shape) is installed into and within the valve body opening 12, against an interior retainer ring groove 1b defined in interior surface 15 of the valve body 1; the retainer ring 10 faces towards, abuts, or is adjacent to the secondary surface 9AB of characterized disc 9A and prevents the dislocation or accidental removal or dislodgement of the characterized disc 9A.

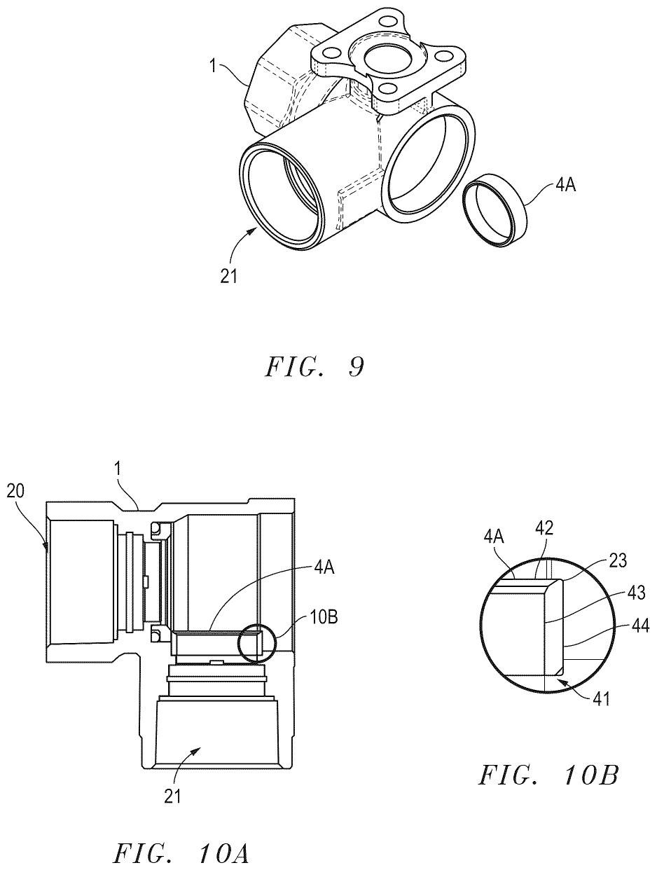

The diverter port seat 4A may also have a substantially annular, ringed, or ring-like shape, having a first or top surface 41 and a second or bottom surface 42 connected by an interior surface 43 and an exterior surface 44 (as may be best depicted in the FIGS. 9-10B). The first or top surface 41 may be a flat surface and the second or bottom surface 42 may have a sloped or curved surface defining the seating area 23 around the circumference, periphery, rim, or edge on or of the second surface 42. The diverter port seat 4A may be, in exemplary embodiments, and not to be limited to, made of polytetrafluoroethylene (PTFE). As can be seen in FIG. 8, the diverter port seat 4A must seal against the ball 3 in the open position 16, which has minimal available sealing area 23 against the outer surface of the ball 3 due to the opening 3a defined for the straight ports 20 and the diverter port 21 in this fully open position 16, leaving minimal material for sealing area or seating capacity 23 for the diverter port 21 in particular. In comparison, the straight port seat 4 has a comparatively larger sealing area or seating capacity 22 for sealing against the surface of the ball 3 and can seal against the surface of the ball 3 with much less difficulty. By way of example only, the straight port seat may have an average of 117.5% more of sealing area or capacity 22 than the sealing area 23, or approximately twice as much sealing area 22 than sealing area 23. Additionally, the sealing area 22 may range from a minimum of 91% more to up to 143% more than sealing area 23. Moreover the straight port seats 4 are much larger and occupies more room (as compared with the diverter seat 4A) in the valve body 1 itself, and thus sealing area on the straight port seat 4 itself is also much larger for engaging the ball 3. The diverter seat 4A is also smaller in size compared to the seat 4, as the valve body 1 has limited space for same. In certain exemplary embodiments, the diverter seat 4A may be on average 58% smaller by volume than the seat 4; additionally, the diverter seat 4A may range from a minimum of 22% to 90% smaller by volume than the seat 4. Additionally, the diverter seat 4A must be noncontiguous with, or alternatively, cannot be in contact with or affect the straight port seat 4 as such would affect the seating capability or integrity of both seats 4 and 4A. The minimal available sealing area 23 of the diverter port seat 4A and the smaller size for the diverter port seat 4A is a challenge which prior art has not been able to address, and accordingly, the prior art has faced and accepted base levels of leakage from the valve 11 for the diverter port 21. In addition, the valve body 1 has very little area for which to insert or provide for a suitable seat 4A for the diverter port 21. Conventional ball valves feature a combined diverter disc and seat, which has less leakage performance or protection and such conventional ball valves must necessarily rerun production tests when the conventional combined diverter disc and seat is replaced, as the seat integrity is compromised when removed from the valve. The exemplary embodiments described herein have a separate diverter disc 9A and diverter seat 4A; an important improvement in the described exemplary embodiments is the capability to replace the diverter disc 9A (i.e. remove the retainer ring 10 and diverter disc 9A and insert a different or new retainer ring 10 and/or different or new diverter disc 9A) without affecting or impacting the seat 4A seating or sealing integrity—thus replacing the diverter disc 9A does not require rerunning production tests to test seat 4A integrity. In certain exemplary embodiments, the seat 4A may be secured to the body 1 and is not intended for removal.

While the exemplary embodiments are described with reference to various implementations and exploitations, it will be understood that these exemplary embodiments are illustrative and that the scope of the inventive subject matter is not limited to them. Many variations, modifications, additions, and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A retention arrangement for a characterized disc for a diverter port in a valve body, wherein the characterized disc for the diverter port has a first surface and a second surface, comprising:
a retainer ring wherein the retainer ring has a first retainer ring side and a second retainer ring side, wherein the retainer ring is adjacent to the characterized disc for the diverter port.

2. The retention arrangement of claim 1, wherein the first surface of the characterized disc for the diverter port is positioned against a shoulder defined in the diverter port of the valve body and the second surface of the characterized disc for the diverter port is positioned facing a valve opening.

3. The retention arrangement of claim 2, wherein the retainer ring is inserted into a groove defined in the diverter port of the valve body, and wherein the retainer ring is adjacent to the second surface of the characterized disc for the diverter port.

4. The retention arrangement of claim 3, further comprising a diverter seat having a first end, an exterior surface and an interior surface, wherein the characterized disc for the diverter port is inserted into the diverter seat and in contact with the interior surface, and wherein the first end of the diverter seat is in sealable contact with a ball of the valve.

5. The retention arrangement of claim 4, wherein the characterized disc for the diverter port is configured to be removable and replaceable from the diverter seat without affecting a seating integrity of the diverter seat.

6. The retention arrangement of claim 5, further comprising a second end of the diverter seat, wherein the second end of the diverter seat is opposite the first end of the diverter seat, and where in the second end of the diverter seat is adjacent to the shoulder.

7. The retention arrangement of claim 6, wherein the valve body further comprises a straight port and a straight port seat inserted into the straight port, and wherein the diverter seat does not contact the straight port seat when installed in valve body.

8. A valve having a straight port and a diverter port defined in a valve body, and a ball rotatable within the valve body between an open position and a closed position of the diverter port, comprising:
a characterized disc in the diverter port, wherein the characterized disc has a first end and a second end;
a retaining ring installed into a groove defined in the valve body and wherein the retaining ring is adjacent to the first end of the characterized disc in the diverter port; and
a diverter seat installed into the valve body and in the diverter port, wherein the diverter seat is located towards the second end of the characterized disc and the diverter seat is configured to seal against the ball.

9. The valve of claim 8, wherein the characterized disc in the diverter port is removable and replaceable from the diverter seat.

10. The valve of claim 9, further comprising a shoulder defined in the diverter port of the valve body, wherein the shoulder comprises a first side surface, a second side surface, and a raised top surface connecting the first side surface and the second side surface.

11. The valve of claim 10, further comprising a flange of the characterized disc in the diverter port, wherein the flange is located at the first end of the characterized disc, and wherein an underside of the flange is adjacent the first side surface of the shoulder.

12. The valve of claim 11, wherein a first end of the diverter seat is adjacent to the second side surface of the shoulder.

13. The valve of claim 12, further comprising a seat in the straight port and wherein the diverter seat does not contact the seat in the straight port when the valve is assembled.

14. The valve of claim 13, wherein the diverter seat defines a first area configured to seal against the ball, and the seat in the straight port comprises a second area configured to seal against the ball, and wherein the first area is less than the second area.

15. A method of assembling a valve having a valve body with a straight port and a diverter port, comprising the steps of:
inserting a ball into the valve body, and a stem into the ball;
inserting a first seat with an O-ring into the straight port, wherein the first seat is adjacent to and sealable against the ball;
inserting a second seat into the diverter port, wherein the second seat is adjacent to and sealable against the ball and is further noncontiguous with the first seat;
inserting a characterized disc into the diverter port and the second seat, wherein an exterior surface of the characterized disc is adjacent an interior surface of the second seat; and
inserting a retaining ring into the diverter port, and adjacent to the characterized disc.

16. The method of claim 15, further comprising the steps of removing the retaining ring from the diverter port and removing the characterized disc from the diverter port without affecting a seating integrity of the second seat.

17. The method of claim 16, further comprising the step of inserting a second characterized disc into the diverter port and into the second seat, without affecting the seating integrity of the second seat.

18. The method of claim 17, wherein the interior surface of the diverter port defines a shoulder having a first side surface and a second side surface and a top surface connecting the first side surface and the second side surface, and wherein a first end of the second seat abuts the first side surface of the shoulder, and the characterized disc abuts the second side surface of the shoulder.
